(19) United States
(12) Patent Application Publication
(10) Pub. No.: US 2008/0263171 A1
(43) Pub. Date: Oct. 23, 2008

(54) Peripheral device that DMAS the same data to different locations in a computer

(75) Inventors: Peter K. Craft, San Francisco, CA (US); Clive M. Philbrick, San Jose, CA (US)

Correspondence Address: MARK A LAUER, 6601 KOLL CENTER PARKWAY, SUITE 245, PLEASANTON, CA, 94566, US

(73) Assignee: Alacritech, Inc.

(21) Appl. No.: 11/788,719

(22) Filed: Apr. 19, 2007

(51) Int. Cl. G06F 15/167

(52) U.S. Cl. 709/212

(57) ABSTRACT

A method is disclosed comprising: receiving,.by a network interface, data and a corresponding header; storing, by the network interface, the data in a first memory buffer of a computer that is coupled to the network interface; and storing, by the network interface, the data in a second memory buffer of the computer. For example, the network interface can first store the data in a part of the computer memory that is accessible by a device driver for the network interface. If the application provides to the driver a pointer to a location in memory for storing the data, the driver can pass this pointer to the network interface, which can write the data directly to that location without copying by the CPU. If, however, the application does not provide a pointer, the data controlled by the driver can be copied by the CPU into the application's memory space.

### TECHNICAL FIELD

The present invention relates to computers and associated peripheral devices, such as a network interface devices, that can access the computer's memory to read and write data, and to networks involving such computers.

### BACKGROUND

As noted in U.S. Pat. No. 6,757,746, which is incorporated by reference herein, one of the most CPU intensive activities associated with performing network protocol processing is the need to copy incoming network data from an initial landing point in system memory to a final destination in application memory. This copying is necessary because received network data cannot generally be moved to the final destination until the associated packets are: A) analyzed to ensure that they are free of errors, B) analyzed to determine which connection they are associated with, and C) analyzed to determine where, within a stream of data, they belong. Until recently, these steps had to be performed by the host protocol stack.

As described in the above-referenced patent, one way to reduce the reduce such copying by a CPU is to provide to the application at least a header corresponding to the data being received, and to have the application return to a network interface a pointer to a location in application memory. The network interface, which may also have the capability to protocol process the received data, can then write the data to the location in application memory designated by the pointer, thereby saving the CPU from copying the data. Direct memory access (DMA) engines can be used to access the computer's memory to store and or retrieve data to avoid such copying by the CPU.

Unfortunately, not all applications will provide a pointer that can be used by a network interface to direct all of the data received by the interface into the appropriate location in the application's memory space. For example, some applications will simply process a header and consume any corresponding data without returning a memory descriptor list that points to a buffer or buffers in application memory space into which related data is to be stored. Moreover, an application may provide such a pointer some of the time and not provide such a pointer at other times, adding to the complexity of attempting to avoid data copying by the CPU.

### SUMMARY

A method is disclosed, the method comprising: receiving, by a network interface, data and a corresponding header; storing, by the network interface, the data in a first memory buffer of a computer that is coupled to the network interface; and storing, by the network interface, the data in a second memory buffer of the computer. For example, the network interface can first store the data in a part of the computer memory that is accessible by a device driver for the network interface. If the application provides to the driver a pointer to a location in memory for storing the data, the driver can pass this pointer to the network interface, which can write the data directly to that location without copying by the CPU. If, however, the application does not provide a pointer, the data controlled by the driver can be copied by the CPU into the application's memory space.

### BRIEF DESCRIPTION OF THE DRAWINGS

FIG. 1 is a schematic plan view of an embodiment including a computer having a peripheral device that stores the same data in different locations in the computer.

FIG. 2 illustrates a first method in which a peripheral device has stored the same data in different locations in the computer.

FIG. 3 illustrates a second method in which a peripheral device has stored the same data in different locations in the computer.

### DESCRIPTION OF THE PREFERRED EMBODIMENT

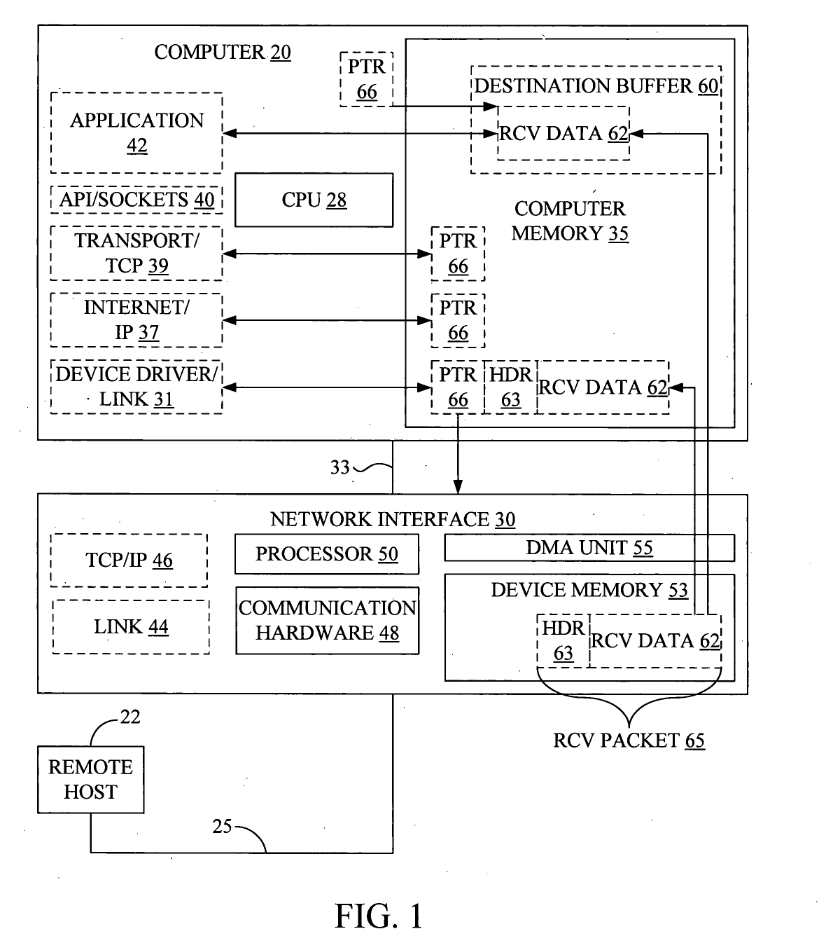

Referring now to FIG. 1, an embodiment can operate in an environment including a computer 20 coupled to a peripheral device 30 such as a network interface, which may for example be a card that is added to the computer or an integrated circuit that is integrated with the computer. Although a network interface is illustrated, other peripheral devices may alternatively be employed. The computer 20 can be a host that is coupled by the network interface 30 to a remote host 22 via a network 25. The host 20 includes a central processing unit (CPU) 28 and a memory 35, while the network interface 30 provides an interface between the host and the network 25. The network 25 is a medium for transmission of information from one computer to another, such as conductive wires, optical fibers or wireless space, including any supporting hardware or software such as switches and routers. Network implementations include local area networks, wide area networks, telecommunication networks and the Internet. For example, an Infiniband fabric or plurality of network interfaces coupled to a backplane as a blade server can be a network. An input/output (I/O) bus 33 such as a peripheral component interface (PCI) or PCI Express bus provides a connection between the computer 20 and peripheral devices such as the network interface 30.

The computer 20 includes software for processing network communications, as well as other software such as instructions that run the computer's operating system. The software for processing network communications is typically categorized as a plurality of layers, sometimes called a protocol processing stack, which include a device driver 31 that communicates with the network interface 30 and provides data-link and media access control (MAC) layer functions. The device driver 31 provides services for an internet layer 37 that includes Internet Protocol (IP) instructions, which in turn services a transport layer 39 that includes Transmission Control Protocol (TCP) instructions. A session layer or application programming interface (API) 40 such as Sockets can provide an interface between the transport layer 39 and an application layer 42, which can include various applications for file transfer, audio, video, text, photos, etc. A network packet received by computer 20 can have its headers analyzed one protocol layer at a time by CPU 28 running the protocol stack, the headers peeled off like the layers of an onion to yield data for application 42. Conversely, data from application 42 can be divided into segments that have protocol layer headers sequentially added by the protocol stack to be sent over the network 25.

The network interface 30 also includes software and/or firmware for processing network communications, such as link layer instructions 44 and TCP/IP instructions 46, which are shown combined in this embodiment. The network interface 30 further includes communication hardware 48 for processing network communications and a processor 50. A device memory 53 containing for example dynamic random access memory (DRAM) and/or static random access memory (SRAM) can be coupled to or integrated with a chip that includes the processor 50 and other hardware. The device memory 53 may store information relevant to controlling communication streams that are handled by the device 30, such as TCP or other control blocks. The device memory 53 may also store information packets that are received from the network 25 or transmitted to the network. DMA engine or engines such as DMA unit 55 can access device memory 53 and computer memory 35, for example to transfer a control block between the two or to store and retrieve data that is communicated over the network 25.

Perhaps the most common set of protocols for transferring information over a network is the Internet Protocol Suite, including IP and TCP. To handle a network message transferred to or from computer 20 via interface device 30, a TCP connection may be set up by computer 20 and then transferred along with other relevant communication control block information to the network interface 30. Having the network interface handle the protocol processing for the message can save the CPU 28 a significant number of processing cycles. The network message may include a number of packets each of which have a TCP and IP header, with the first packet also including a session layer and/or application layer header that provides some information about the data in all of the packets, such as the length of the data and the application context that it corresponds to, such as a file or session. With the interface device 30 controlling the TCP connection and capable of performing IP and TCP processing, data from a message received from the network 25 may be transferred to the application file in the computer memory 35 without the computer performing protocol processing or copying.

The DMA unit 55 may transfer received data from the device memory 53 to the computer memory 35, thereby saving the CPU from copying the data between the memories. In order for the DMA unit 55 to transfer received data to the destination in the computer memory 35 required by the application, the application can provide a pointer 66 to a destination buffer 60 corresponding to a file for the application 42, with the pointer passed down through the protocol stack and forwarded to the network interface 30. Although a pointer is specifically mentioned in this embodiment, other data structures known to those of skill in the art to indicate a location for storing or retrieving data can be alternatively employed, such as a memory descriptor list (MDL), and are generally represented by the word pointer. To provide that pointer, at least a header 63 portion of a message packet 65 can be provided to the application 42 by DMA unit 55, which can transfer that header to the computer memory 35 under control of the device driver 31. The TCP/IP information in the header can be processed by the protocol stack to determine the TCP port number corresponding to the application 42. The session or application layer header information can then be processed to allocate the destination buffers 60, and a descriptor pointing to those buffers can be passed from the application to the TCP/IP layers, the device driver, and the network interface, so that the DMA unit 55 can transfer received data directly into the application memory space 60.

As mentioned above, however, an application may or may not provide a pointer to destination buffers for an application file. For example, an application may simply consume the header and any related data provided to it and wait for more, without indicating to lower layers where in the computer memory 35 to place related data. For this reason, instead of merely providing a header portion of a first message packet to the device driver, the DMA unit 55 may provide the full packet, so that if the header is consumed by the application without returning a pointer, the data will also be placed in the correct location in application memory space. Unfortunately, this entails copying of the application data by the CPU 28, to move the data from a location in general computer memory 35 under control of the device driver 31 to the desired destination such as a file cache for the application 42. Moreover, because the network interface 30 does not know in advance whether an application will return a pointer or simply consume data, and therefore provides the full packet to the computer 20, the advantage of avoiding CPU copying for the case in which a pointer is returned is negated. Even more troubling is the fact that, by providing the full packet rather just the first few hundred bytes, the application 42 may be encouraged to consume the data and promote further CPU copying as opposed to providing a pointer that can used by the DMA unit to place the data in the destination buffer 60.

Faced with this quandary, the present inventors came up with the novel solution of using the DMA unit to write the same packet data into the destination buffer 60 as was previously written into the computer memory 35 under control of the device driver, for the situation in which a pointer to the destination buffer 60 is returned. That is, instead of having the CPU copy the data from one part of the computer memory 35 to another for this situation, the pointer to the destination buffer 60 is sent from the device driver 31 to the network interface 30, for example as a Receive MDL command, which allows the DMA unit to write the data into the destination buffer 60 denoted by the pointer. Although it is redundant to transfer the same data twice between the peripheral device and the computer, and such duplication will result in an extra interrupt when the interface informs the host that the application buffer has been filled, such a double DMA saves the CPU from copying the data.

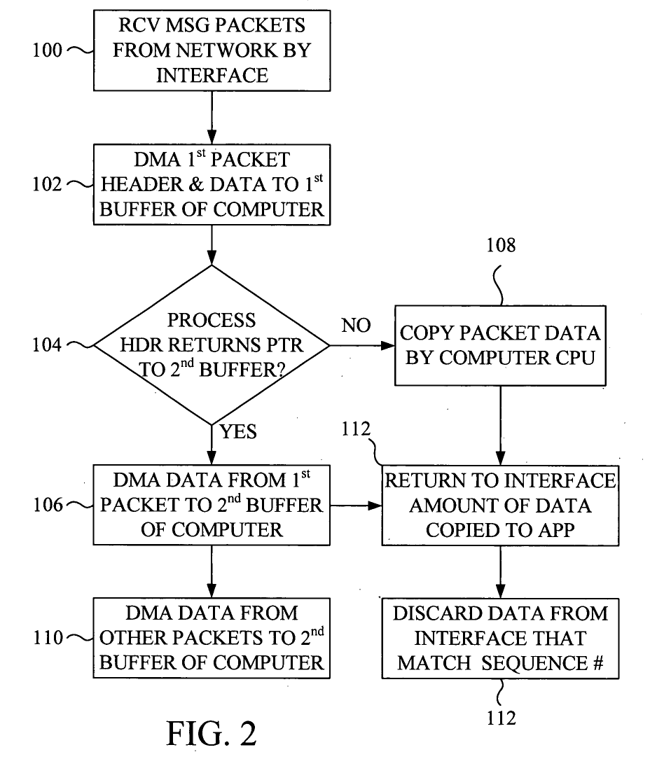

FIG. 2 shows some steps that can be performed in accordance with one embodiment. In step 100, a network interface can receive a number of message packets destined for a host computer to which the network interface is coupled. Initial steps such as setting up a connection corresponding to that message and transferring the connection to the network interface, such as described in the above-referenced U.S. Pat. No. 6,757,746, are omitted to facilitate understanding of the present invention. In step 102, a DMA engine of the network interface can write a first of the message packets to a first memory buffer of the computer, the first message packet containing data and a corresponding header. In step 104, the application processes the header and may create a pointer to a location in memory that has been allocated for the application context or file corresponding to the message, which may be called a destination or second buffer, after which the device driver can provide the pointer indicating the destination buffer to the network interface. In step 106, the DMA engine of the network interface can use the pointer to store the same message packet data in the second memory buffer of the computer. After the data has been stored in the second memory buffer the device driver may discard the data stored in the first buffer. For the case in which a pointer to the second buffer has been passed to the network interface, data from the remaining message packets can be stored by DMA in the second buffer, after the data from the first packet has been stored in the second buffer, as shown by step 110.

If a pointer is not returned upon processing the header, as shown in step 108, the CPU of the computer may instead copy the packet data to the location desired by the application. For the situation in which a pointer has not been returned and the computer has copied the data from the first packet, the DMA engine may repeat the process beginning with step 102 by storing the header and data of a second of the message packets in a general buffer of the computer.

Because the network interface may or may not need to DMA the same data to the second buffer that it earlier provided to the first buffer, the network interface can maintain a copy of the data until it receives a signal from the computer that the data has been stored in its destination for the application. Once the data has been stored at the application, the application can return an indication of the amount of data that has been stored, as shown in step 112. To do this, the application can provide the sequence numbers of the data that has been stored, or simply communicate to the network interface the amount of bytes consumed, for example by the same or similar mechanism as a window update. When the byte count or sequence numbers have been provided to the network interface confirming that the data has successfully landed at the application, the network interface can then discard the data in its memory.

Using the sequence numbers or byte count of the data that has been successfully stored at the application can also help to avoid a race condition. For example, when receiving a message the network interface may DMA the first two packets of the message to the device driver before the device driver returns a pointer to the application memory space along with a command not to send any more packets to the driver. The interface would then DMA the data from the first packet to the location in application memory space indicated by the pointer and may then DMA the data from a third packet it has received, without accounting for the second packet, which is in a queue at the driver waiting for processing. This could cause data to be placed in the destination buffer in the wrong order and perhaps the loss of the data from the second packet. To avoid these errors, a byte count or the sequence numbers of the data received by the application can be used to ensure that the data is placed in the destination buffer in the correct location.

The amount of data to be dropped can be communicated to the device as part of a window update mechanism that is used to advertise the receive window available for storing data. In addition, the network interface can simplify and accelerate the process of coordinating the byte count or sequence numbers for storage by DMA by maintaining a window update register, with a part of the register devoted to listing the byte count or sequence numbers and another part of the register devoted to listing the TCB associated with the stored data.

That is, the window update value passed to the interface used to have the single purpose of telling the card to increase its current window size, but now has the additional purpose of instructing the interface to discard that number of bytes that have accumulated on its receive queue. Note that since a window update reflects the amount of data consumed by an application, the first byte of data on the receive queue following a window update should reflect the next byte to be delivered to the application. One embodiment includes a modification to the pure window update handling, which had previously been accomplished with a window update command. The embodiment implements a new window update register whereby the value written to it contains the window update amount in bits 0-19, and bits 20-31 contain the TCB number. This change can replace a command allocation, command initialization, register write, interrupt, command completion processing, and command and response buffer freeing with just a simple register write.

In order to have a peripheral device store the same data in two different buffers of the computer at two different times, the peripheral device may maintain a copy of the data after it has been stored in the first location, and then access the copy to store the data in the second location, as described above. On the other hand, for example when peripheral device memory is scarce, the peripheral device may copy the data from the first location in order to store the data in the second location.

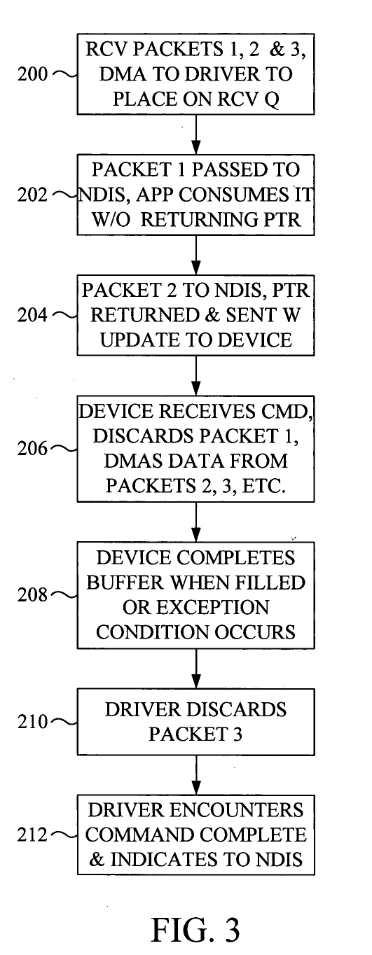

FIG. 3 provides an example of the behavior of one embodiment that receives data via a network interface coupled to a computer. For the sake of convenience, the example assumes that a number of approximately 1 kB packets are received from a network, and that a connection has already been established for the packets that is maintained on the interface. In step 200, the network interface receives packets 1, 2 and 3 and DMAs the packets to a device driver of the computer, which places the segments on a receive queue. The network interface may also perform protocol processing on the packets, for example using specialized protocol processing hardware and/or a processor.

In step 202, the device driver processes its receive queue, encounters packet 1 and provides (sometimes called indicates) it to the protocol stack for example using an interface such as Network Driver Interface Specification (NDIS). NDIS returns the communication NDIS_STATUS_SUCCESS, which means that the application has consumed the packet by copying the data to its destination without returning a pointer to that destination. In step 204, the device driver encounters packet 2 and indicates it to NDIS, but this time the application does not consume the data and NDIS instead responds with a pointer to a buffer for the data. The device driver gives the pointer to the card with a Receive MDL command. The Receive MDL command contains a window update value of 1 kB to reflect the fact that packet 1 was consumed. The device driver may at this time discard segment 1.

In step 206, the network interface receives the command and, based on the window update value of 1 k, discards segment 1. The network interface begins to fill the buffer with segment 2, then with segment 3, and continues with subsequently received segments.

In step 208, the network interface Completes the Receive MDL command when the buffer has been filled or some other situation occurs (flush, push frame, etc.).

In step 210, the device driver, meanwhile, encounters segment 3 on its receive queue, recognizes that it has a buffer outstanding on the card and discards it.

The device driver encounters the Receive MDL command completion and completes the corresponding buffer to NDIS. At this point the process can be repeated to receive another message containing data for the computer.

One of the issues that arises out of this embodiment is that the Receive MDL command completion should be synchronized with the delivery of data buffers to the host. Previously, command completions were placed on a different host queue than data buffer indications. In one embodiment, Receive MDL command completions are modified so that they are placed on the same queue as data buffers. To implement this a new fastpath frame type has been defined and the header buffer data structure has been modified to include the hosthandle and resid values that had been placed in the response buffer. Further, the status field of the header buffer structure may be modified to include the Receive MDL completion status values that had been placed in the response buffer.

From the last section it would be tempting to assume that once a Receive MDL command has been given to the card the host could blindly discard data buffers found on its receive queue until it encounters the command completion. This is not the case. Consider a situation, for example, in which the interface sends ten 1 kB buffers to the interface driver. These buffers accumulate on the receive queue until the interface driver finally encounters the first of them. When the first segment is given to NDIS, NDIS rejects it and responds with a 5 kB buffer. This 5 kB buffer is given to the card and subsequently completed.

Were the interface driver to blindly discard data buffers until it encounters the command completion, it would end up discarding all 10 1 kB buffers, resulting in data corruption.

A possible solution to this problem would be to simply have the host keep track of data buffer space outstanding and simply drop data buffers until that amount has been accounted for. In other words, with this example, the host would drop the indicated segment and then the subsequent 4 segments found on the receive queue, but then queue the remainder that it discovers prior to the MDL completion. The problem with this solution is that there is no guarantee that the interface won't perform a short completion of the MDL due to, for instance, the arrival of a PUSH frame.

A preferred way to solve this, then, is to continue to queue receive data buffers on the host data buffer queue while the MDL is outstanding. When the MDL is completed, data will be dropped off of the data buffer queue. The amount of data to be dropped will be: MIN(MDL-bytes-filled, Total-data-buffer-bytes).

Note, for instance that the amount of data queued to the data buffer may be greater than or less than the amount of bytes filled in the completed MDL. It would be greater than the bytes filled if the buffer is smaller than the amount of data received (as in the example present here) and it could be less than if the MDL is handed to the interface prior to the arrival of the segments associated with it.

It may be worth noting some edge-case scenarios. Consider the arrival of two 1 kB segments and a 1.5 kB buffer. If the second segment arrives prior to the Receive MDL command, then both segments will be queued to both the interface driver's data buffer queue and the interface's receive queue. The interface will DMA 1.5 kB of the data into the host, drop 1.5 kB of data off of its receive queue and complete the MDL command—leaving the remaining 0.5 kB of data on its receive queue. The interface driver, upon the completion of the command, will complete the corresponding buffer to NDIS and then also drop 1.5 kB of data off of its receive queue. It will then indicate the remaining 0.5 kB of data to NDIS. Assuming the data is consumed, the interface driver will subsequently issue a window update to the interface (in one form or another) for the 0.5 kB of consumed data, which will cause the interface to drop the corresponding data off of its receive queue. Alternatively, if the indicated 0.5 kB is refused by NDIS and a buffer is provided instead, the buffer will be handed to the interface in a second Receive MDL command. The interface will DMA the 0.5 kB into the new MDL (along with subsequent data depending on the length of the MDL) and complete the second MDL, at which time the host will drop the remaining 0.5 kB. Note that the interface does not send the remaining 0.5 kB from the first MDL to the host after the command completion because it had already been sent as a data buffer prior to the arrival of the MDL command.

Conversely, consider the case in which the 1.5 kB MDL command is issued to the interface prior to the arrival of the second segment. In this case, the interface and the host both have a single 1 kB segment on their respective receive queues. The interface DMAs the segment to the buffer and drops it. Then, when the second segment arrives, the interface fills the remaining 0.5 kB of the buffer with half of the segment and completes the command. It subsequently passes the remaining 0.5 kB into the host as a data buffer. The interface driver receives the command completion and, based on the MIN(MDL-bytes-filled, Total-data-buffer-bytes) calculation disclosed above, drops 1 kB (all of its queued bytes) off of it's receive queue. It then receives the 0.5 kB data buffer sent in following the completion of the command and indicates it to NDIS.

In both of these cases, the first 1.5 kB is DMAd into the buffer and the remaining 0.5 kB is subsequently indicated to NDIS.

In one embodiment the method by which a connection is transferred from a host to a network interface (sometimes called a connection handout) is changed from that previously used. Previously, for example as in the referenced U.S. Pat. No. 6,757,746, a connection could be handed out when there was data on the interface driver's receive data queue. When this situation occurred, the receive parameters of the TCB reflected the unconsumed data (RcvWnd was less than MaxRcvWnd and less than a full window existed between RcvNxt and RcvAdv). Then, when the data was subsequently consumed by the application, a window update was sent to instruct the interface to open its window (increase RcvWnd and advance RcvAdv).

The problem with this situation in one embodiment of the new receive method is that when the interface receives a window update it also expects to drop an equivalent amount of data off of its receive queue. In this case, since the host's accumulated receive data had arrived via slowpath, the interface will not have a copy of this data.

One solution to this is to defer the second phase of the handout until all of the received data on the host has been consumed. Note that we must defer the second phase of the handout to resolve this situation and not the start of the handout. Deferring the start of the handout risks the possibility that data may arrive as the connection is handed out, while the interlock that precedes the second phase of the handout ensures that no more slowpath data can accumulate on the hosts receive queue.

One possible concern here is that we could theoretically end up stuck in mid-handout for a long time if we are stuck waiting for the application to consume the data. It is not clear how often that is likely to occur or what the ramifications are if it does. Another possible solution to this issue is to define a second Window Update value that means “Open the window, but don't attempt to drop data.” Alternatively, the interface could calculate the amount of unconsumed data at handout time based on the TCB receive fields and then allow that value to decrement as it receives window updates from the host. When it drops to zero it can then begin dropping data off of the receive queue.

Although we have described in detail a number of exemplary embodiments of the invention, those examples are not intended to limit the invention, and those of ordinary skill in the art will recognize that other embodiments and modifications can be made that are within the scope of the invention as defined by the following claims. We also realize that other inventions are supported by the disclosure, but are not claimed in the following claims due to the likelihood that they would be subject to restriction requirements that would waste the fees required to file those claims.

1. A method comprising:
receiving, by a network interface, data and a corresponding header;
storing, by the network interface, the data in a first memory buffer of a computer that is operably coupled to the network interface; and
storing, by the network interface, the data in a second memory buffer of the computer.

2. The method of claim 1, wherein the data is part of a message containing related data, further comprising:
copying, by the computer, the related data from the first memory buffer to the second memory buffer.

3. The method of claim 2, further comprising:
providing, to the network interface, a byte count corresponding to the related data that has been copied to the second memory buffer; and
discarding the related data from the network interface in response to receiving the byte count.

4. The method of claim 2, further comprising:
providing, to the network interface, a sequence number corresponding to the related data that has been copied to the second memory buffer; and
discarding the related data from the network interface in response to receiving the sequence number.

5. The method of claim 1, further comprising:
processing the header by the computer, after the storing of the data in the first memory buffer and before the storing of the data in the second memory buffer.

6. The method of claim 1, further comprising:
maintaining, at the network interface, a copy of the data after the storing of the data in the first memory buffer; and
accessing the copy for the storing of the data in the second memory buffer.

7. The method of claim 1, wherein the network interface copies the data from the first memory buffer to the second memory buffer.

8. The method of claim 1, further comprising:
copying, by the network interface, the data in the first memory buffer, for the storing of the data in the second memory buffer.

9. The method of claim 1, wherein the data in the first memory buffer is controlled by a device driver running on the processor, and the data in the second memory buffer is controlled by an application running on the processor.

10. The method of claim 1, wherein the header includes Transmission Control Protocol (TCP) information.

11. The method of claim 1, wherein the network interface includes a direct memory access (DMA) engine that performs the storing.

12. The method of claim 1, further comprising:
discarding the data in the first memory buffer of the memory, in response to the storing, by the network interface, the data in a second memory buffer of the computer.

13. A method comprising:
receiving, by a network interface that is operably coupled to a computer having a processor and a memory, a message including a plurality of packets;
storing, by the network interface, first data from a first of the packets in a first location of the memory; and
storing, by the network interface, the first data in a second location of the memory.

14. The method of claim 13, further comprising:
copying, by the computer, second data from a second of the packets to the second location.

15. The method of claim 14, further comprising:
providing, to the network interface, a sequence number corresponding to the second data that has been copied to the second location; and
discarding the second data from the network interface in response to receiving the sequence number.

16. The method of claim 13, further comprising:
processing, by the processor, a header corresponding to the first data, including obtaining a pointer to the second location in the memory.

17. The method of claim 13, further comprising:
discarding the first data in the first location of the memory, in response to receiving a signal that the first data has been saved in the second location in memory.

18. The method of claim 13, further comprising:
maintaining, at the network interface, a copy of the first data after the storing of the first data in the first location.

19. The method of claim 13, further comprising:
storing, in a register, an indication of a control block corresponding to the message and a byte count corresponding to message data that has been consumed by an application running on the processor.

20. The method of claim 13, further comprising:
storing, in a register, an indication of a control block corresponding to the message and a sequence number corresponding to message data that has been consumed by an application running on the processor.

21. The method of claim 13, wherein data in the first location is controlled by a device driver running on the processor, and data in the second location is controlled by an application running on the processor.

22. The method of claim 13, wherein the header includes Transmission Control Protocol (TCP) information.

23. The method of claim 13, wherein the network interface includes a direct memory access (DMA) engine that performs the storing.

24. An apparatus comprising:
a computer having a processor and a memory; and
a peripheral device that is operably coupled to the computer, the peripheral device adapted to store a block of data in two different locations of the memory.

25. The apparatus of claim 24, wherein the peripheral device contains a direct memory access (DMA) unit that accesses the memory to store the block of data in the two different locations of the memory.

26. The apparatus of claim 24, further comprising a register adapted to store an indication of a control block corresponding to the message and a byte count corresponding to message data that has been consumed by an application.

27. The apparatus of claim 24, further comprising a register adapted to store an indication of a control block corresponding to the message and a sequence number corresponding to message data that has been consumed by an application.

28. The apparatus of claim 24, further comprising:
an application running on the computer and receiving a message; and
a register adapted to store an indication of a control block corresponding to the message and a byte count corresponding to message data that has been consumed by the application.

29. The apparatus of claim 24, further comprising:
an application running on the computer and receiving a message; and
a register adapted to store an indication of a control block corresponding to the message and a sequence number corresponding to message data that has been consumed by the application.

30. An apparatus comprising:
a computer having a processor and a memory that holds the same data in two different locations; and
a peripheral device that is operably coupled to the computer, the peripheral device adapted to access the memory and having a device memory that holds a copy of the data that is stored in two different locations.
